(19) United States
(12) Patent Application Publication
(10) Pub. No.: US 2026/0141581 A1
(43) Pub. Date: May 21, 2026

(54) METHOD AND SYSTEM FOR CONTEXT-BASED DYNAMIC TRANSFORMATION OF SURFACE REFLECTION OF A VIRTUAL ENTITY

(71) Applicant: SAMSUNG ELECTRONICS CO., LTD., Suwon-si (KR)

(72) Inventors: Prabodh KUMAR, Noida (IN); Chinar GOEL, Noida (IN)

(73) Assignee: SAMSUNG ELECTRONICS CO., LTD., Suwon-si (KR)

(21) Appl. No.: 19/447,814

(22) Filed: Jan. 13, 2026

Related U.S. Application Data
(63) Continuation of application No. PCT/KR2024/014429, filed on Sep. 25, 2024.

(30) Foreign Application Priority Data
Oct. 16, 2023 (IN) 202311070007

(51) Int. Cl. G06T 11/00; G06F 3/01; G06T 7/10; G06T 7/70

(52) U.S. Cl. CPC G06T 11/00; G06T 7/10; G06T 7/70; G06F 3/011; G06T 2207/20084; G06T 2207/30196

(57) ABSTRACT

A system and a method for context-based dynamic transformation of a surface reflection of a virtual entity in a virtual environment. The method includes generating image context vectors and extended reality context vectors based on media data and content data corresponding to the virtual environment. Furthermore, the method includes determining whether a mapping index value corresponding to the similarity mapping is greater than a predefined threshold value associated with the mapping index. Further, the method includes determining at least one relevant contextual image vector with respect to the extended reality context vectors based on a content relevance ranking index. The method further includes generating a conditional tensor of the virtual entity. Moreover, the method includes transforming the surface reflection of the virtual entity whereby the surface reflection of the virtual entity is controlled to reflect context-based effect based on the generated conditional tensor.

### CROSS-REFERENCE TO RELATED APPLICATION

This application is a continuation application, under 35 U.S.C. § 111 (a), of international application No. PCT/KR2024/014429, Sep. 25, 2024, which claims priority under 35 U. S. C. § 119 to Indian Patent Application number 202311070007, filed Oct. 16, 2023, the disclosures of which are incorporated herein by reference in their entireties.

### TECHNICAL FIELD

The present invention generally relates to a field of image processing, and more particularly relates to a method and a system for context-based dynamic transformation of a surface reflection of a virtual entity in a virtual environment.

### BACKGROUND ART

In recent years, a rise of social platforms and online gaming communities played a crucial role in further development of concept of Metaverse and virtual world, particularly regarding personal avatar creation for the social platforms and the online gaming communities. These platforms provided infrastructure and tools for users to create and customize their avatars, allowing them to express their individuality within virtual worlds. As demand for more immersive experiences increased, companies began offering extensive avatar customization options, including an ability to adjust facial features, body proportions, clothing, and accessories. With the rise of the metaverse concept, which envisions a shared virtual space where users can interact with each other and explore various digital environments, the personal avatar creation has become even more important.

A virtual world, also referred to as a virtual space, a virtual environment, or a metaverse, is a computer-simulated environment which may be populated by many users who can create a personal avatar (also referred to as a virtual entity), and simultaneously and independently explore the virtual world. Such a personal avatar creates a virtual appearance of the user in the virtual environment. The avatar of the user is generally preferred to represent realistic characteristics of the user. Such characteristics include, similar hairs, similar face structure, similar clothes, similar walking style, and so forth.

Further, various attempts have been made to make the virtual environment more personalized and innovative to the user. However, there is a distinct shortage of personalization of the underutilized modality (such as, avatar's reflection) for user interaction. Though the avatar's reflection presents a huge opportunity to provide a more personalized and innovative experience to the user, there is no conventional technique which provides any feature to personalize the avatar's reflection.

This lack of personalization often leads to user dissatisfaction and is not favourable for developing an interest of the user in the virtual environment.

Further, conventional techniques include modifying a user's avatar based on an event. Specifically, when a relevant event is detected, the convention techniques may initiate a change in avatar's appearance or characteristics. This could involve changes in clothing, facial expression, etc. However, applying changes directly to avatar's appearance like clothing, etc., could be disrupting for the user. As the user may want to maintain the consistency of their avatar's appearance while still having a dynamic element that reflects their real-life context or metaverse context.

Accordingly, there is a need to overcome at least the above-mentioned challenges in the virtual environment.

### DISCLOSURE

### Technical Solution

This summary is provided to introduce a selection of concepts, in a simplified format, that are further described in the detailed description of the invention. This summary is neither intended to identify key or essential inventive concepts of the invention and nor is it intended for determining the scope of the invention.

According to one embodiment of the present disclosure, a method for context-based dynamic transformation of a surface reflection of a virtual entity in a virtual environment is disclosed. The method includes obtaining media data corresponding to the virtual entity and content data including extended reality frame of view data and metadata corresponding to the virtual environment including the virtual entity. The method also includes generating a plurality of image context vectors and a plurality of extended reality context vectors based on the media data and the content data. The method further includes filtering, based on a similarity mapping between the plurality of image context vectors and the plurality of extended reality context vectors, one or more image context vectors among the plurality of image context vectors that are similar to one or more context vectors among the plurality of extended reality context vectors. Furthermore, the method includes determining whether a mapping index value corresponding to the similarity mapping is greater than a predefined threshold value associated with the mapping index value. Further, upon determining that the mapping index value is greater than the predefined threshold value, the method includes determining at least one relevant contextual image vector with respect to the plurality of extended reality context vectors based on a content relevance ranking index. Moreover, the method includes generating a conditional tensor of the virtual entity by concatenating the at least one relevant contextual image vector with a plurality of reflection attributes associated with the virtual entity and at least one spatial attributes tensor corresponding to the virtual entity. Furthermore, the method includes transforming, using a Generative Adversarial Networks (GAN) model, the surface reflection of the virtual entity whereby the surface reflection of the virtual entity is controlled to reflect context-based effect based on the generated conditional tensor.

According to another embodiment of the present disclosure, a system for context-based dynamic transformation of a surface reflection of a virtual entity in a virtual environment is disclosed. The system includes a memory and at least one processor communicably coupled with the memory. The at least one processor is configured to obtain media data corresponding to the virtual entity and content data including extended reality frame of view data and metadata corresponding to the virtual environment including the virtual entity. The at least one processor is also configured to generate a plurality of image context vectors and a plurality of extended reality context vectors based on the media data and the content data. Further, the at least one processor is configured to filter, based on a similarity mapping between the plurality of image context vectors and the plurality of extended reality context vectors, one or more image context vectors among the plurality of image context vectors that are similar to one or more context vectors among the plurality of extended reality context vectors. Moreover, the at least one processor is configured to determine whether a mapping index value corresponding to the similarity mapping is greater than a predefined threshold value associated with the mapping index value. Further, upon determining that the mapping index value is greater than the predefined threshold value, the at least one processor is configured to determine at least one relevant contextual image vector with respect to the plurality of extended reality context vectors based on a content relevance ranking index. Also, the at least one processor is configured to generate a conditional tensor of the virtual entity by concatenating the at least one relevant contextual image vector with a plurality of reflection attributes associated with the virtual entity and at least one spatial attributes tensor corresponding to the virtual entity. Furthermore, the at least one processor is configured to transform, using a Generative Adversarial Networks (GAN) model, the surface reflection of the virtual entity whereby the surface reflection of the virtual entity is controlled to reflect context-based effect based on the generated conditional tensor.

To further clarify the advantages and features of the present invention, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings.

### DESCRIPTION OF DRAWINGS

These and other features, aspects, and advantages of the present invention will become better understood when the following detailed description is read with reference to the accompanying drawings in which like characters represent like parts throughout the drawings, wherein:

FIGS. 1A and 1B illustrate an environment for context-based dynamic transformation of a surface reflection of a virtual entity, according to one or more embodiments of the present disclosure;

FIG. 2 illustrates a schematic block diagram of a system for context-based dynamic transformation of the surface reflection of the virtual entity in a virtual environment, according to an embodiment of the present disclosure;

FIG. 3 illustrates a process flow of a method for context-based dynamic transformation of the surface reflection of the virtual entity in the virtual environment, according to an embodiment of the present disclosure;

FIG. 4 illustrates an architectural block diagram of a system for context-based dynamic transformation of the surface reflection of the virtual entity in the virtual environment, according to an embodiment of the present disclosure;

FIG. 5 illustrates a process flow of dynamically transforming the surface reflection of the virtual entity in the virtual environment, according to an embodiment of the present disclosure;

FIG. 6 illustrates a first example scenario depicting a virtual entity with a dynamically transformed surface reflection in a virtual environment, according to an embodiment of the present disclosure;

FIG. 7 illustrates a second example scenario depicting a virtual entity with a dynamically transformed surface reflection in a virtual environment, according to another embodiment of the present disclosure;

FIG. 8 illustrates a third example scenario depicting a virtual entity with a dynamically transformed surface reflection in a virtual environment, according to yet another embodiment of the present disclosure;

FIG. 9 illustrates a fourth example scenario depicting a virtual entity with a dynamically transformed surface reflection in a virtual environment, according to yet another embodiment of the present disclosure;

FIG. 10 illustrates a first use case example diagram depicting various virtual entities with dynamically transformed surface reflections in a virtual environment, according to an embodiment of the present disclosure;

FIG. 11 illustrates a second use case example diagram depicting various virtual entities with dynamically transformed surface reflections in a virtual environment, according to another embodiment of the present disclosure; and

FIG. 12 illustrates an exemplary process flow of a method for context-based dynamic transformation of the surface reflection of the virtual entity in the virtual environment, according to an embodiment of the present disclosure.

Further, skilled artisans will appreciate that elements in the drawings are illustrated for simplicity and may not have necessarily been drawn to scale. For example, the flow charts illustrate the method in terms of the most prominent operations involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### BEST MODE

### Mode for Invention

For the purpose of promoting an understanding of the principles of the invention, reference will now be made to the various embodiments and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in another embodiment” and similar language throughout this specification may, but do not necessarily, all refer to the same embodiment.

The terms “comprise”, “comprising”, or any other variations thereof, are intended to cover a non-exclusive inclusion, such that a process or method that comprises a list of steps (operations) does not include only those steps (operations) but may include other steps (operations) not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

The terms like “metaverse”, “virtual environment”, “virtual world”, or “virtual space” may be used interchangeably throughout the description.

The present disclosure is directed toward a system and a method for dynamic transformation of a surface reflection corresponding to a metaverse entity. The technique for the present disclosure includes generating the dynamic, personalized and/or contextual reflection of the metaverse entity based on social media profile of a user of the metaverse, images in a mobile computing device of the user, likes/dislikes of the user, and other related parameters such provide a personalized experience to the user.

The terms “metaverse entity” or “virtual entity” may correspond to a virtual avatar of the user, or a digital representation of an object, a building, a person, or an animal in the metaverse/virtual environment.

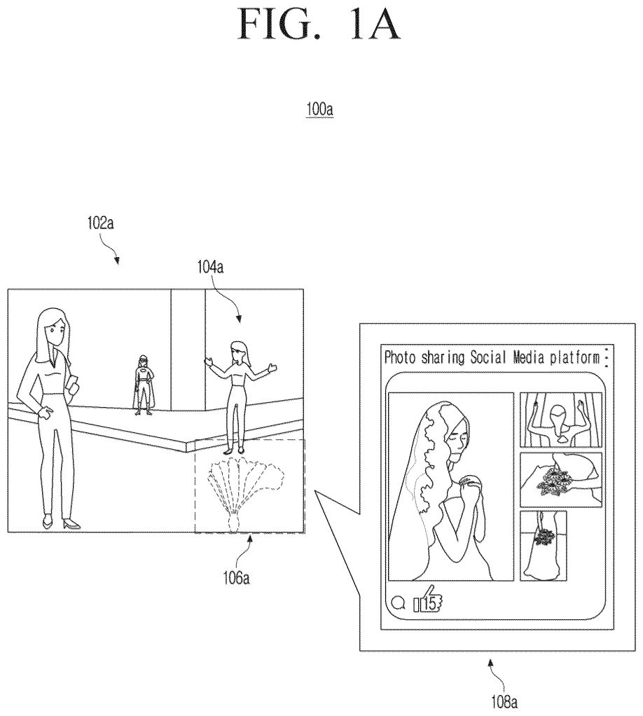

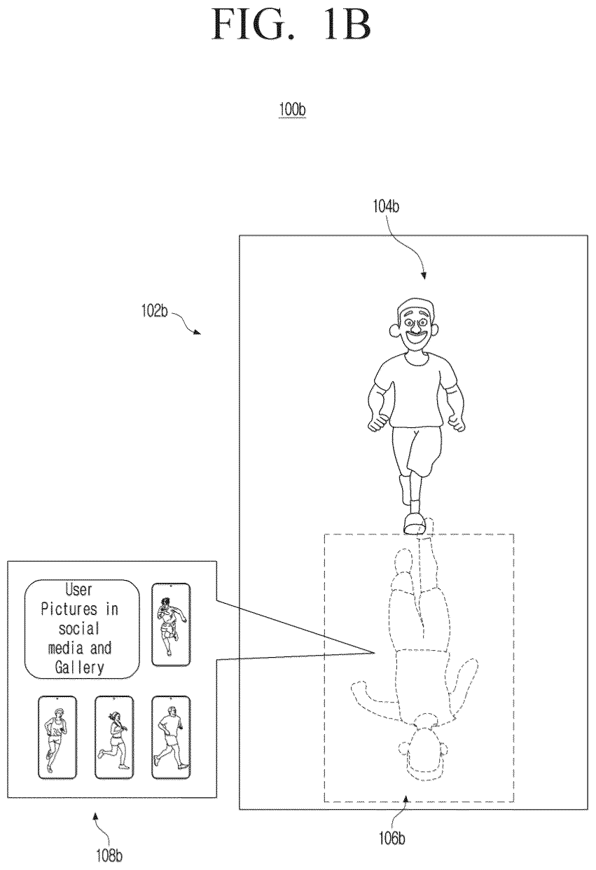

FIG. 1A illustrates an exemplary environment 100a for generating a surface reflection 106a (also referred to as “the surface reflection 106”) of a virtual entity 104a (also referred to as “the virtual entity 104”) in a metaverse 102a (also referred to as “the metaverse 102”), according to an embodiment of the present disclosure. The metaverse 102 may be defined as a virtual, interconnected, and immersive digital universe or space where users can interact with each other and the digital universe. Further, in a non-limiting example, the metaverse 102 may be defined as a virtual shared space that encompasses various aspects of the digital world, such as Augmented Reality (AR), Virtual Reality (VR), social media, online gaming, and other digital experiences. In some embodiments, the virtual entity 104 may include, but is not limited to, an object, a building, digital objects, and animals. In the illustrated embodiment, the virtual entity 104 may correspond to an avatar of a user of the metaverse 102. In FIG. 1, the virtual entity 104 has been illustrated with a dynamic and personalized surface reflection 106. In one embodiment, the surface reflection 106 may correspond to a shadow of the user. In other embodiments, the surface reflection may correspond to an image of an object, an image of the user, an image of an animal, an image of a character, and so forth.

In an exemplary embodiment, the surface reflection 106 corresponds to a dynamically transformed surface reflection based on a social media profile of the user. Specifically, the surface reflection 106 corresponds to an image shared by the user on the social media profile 108a. Further, the surface reflection 106 may be rendered with different levels of privacy based on a viewer of the surface reflection 106 and a relation of the user with the viewer.

Therefore, by dynamically transforming the surface reflection of the virtual entity 104 corresponding to the user, the present disclosure may enhance user experience and interaction of the user in the metaverse 102.

FIG. 1B illustrates an exemplary environment 100b for generating a surface reflection 106b of a virtual entity 104b in a metaverse 102b, according to an embodiment of the present disclosure. In the illustrated scenario of FIG. 1B, the metaverse 102b may correspond to a stadium for a marathon, and the virtual entity 104b may correspond to an avatar of a user participating in the marathon, as shown in FIG. 1B. The surface reflection 106b of the virtual entity may be changed to an image of the user which may be derived from a social media profile 108b of the user, or an image storage location of a mobile device associated with the user. Furthermore, the surface reflection 106b may be transformed based on an activity and/or context associated with the virtual entity 104b. For example, the surface reflection 106b may correspond to a real-life appearance of the user while running.

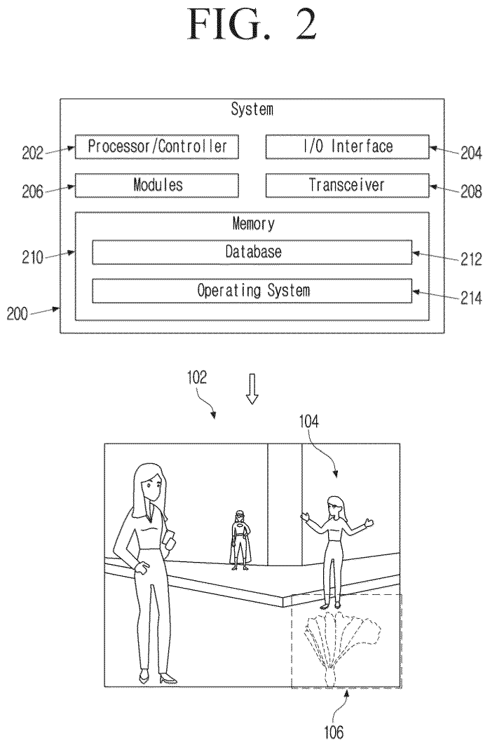

FIG. 2 illustrates a schematic block diagram of a system 200 for context-based dynamic transformation of a surface reflection of a virtual entity in a virtual environment, according to an embodiment of the present disclosure. For example, the system 200 may be configured to generate the dynamically transformed surface reflection 106 corresponding to the virtual entity 104 in the metaverse 102. In an embodiment, the system 200 may be included within an electronic/user device configured to provide a virtual reality experience to the user and/or to generate a virtual environment for the user. In another embodiment, the system 200 may be configured to operate as a standalone device or a system based in a server/cloud architecture communicably coupled to the electronic device. Examples of the electronic device may include, but are not limited to, a mobile phone, virtual reality headset, virtual reality glasses, and or any other smart device configured to generate and provide virtual environment to a user as discussed throughout this disclosure.

The system 200 may be configured to receive and process social media profile of user, a storage location of an electronic device associated with the user, and/or parameters related to a virtual environment for context-based dynamic transformation of surface reflection of a virtual entity in the virtual environment. The system 200 may include a processor/controller 202, an Input/Output (I/O) interface 204, one or more modules 206, a transceiver 208, and a memory 210.

In an exemplary embodiment, the processor/controller 202 may be operatively coupled to each of the I/O interface 204, the modules 206, the transceiver 208, and the memory 210. In one embodiment, the processor/controller 202 may include at least one data processor for executing processes in Virtual Storage Area Network (VSAN). In another embodiment, the processor/controller 202 may include specialized processing units such as, integrated system (bus) controllers, memory management control units, floating point units, graphics processing units, digital signal processing units, etc. In one embodiment, the processor/controller 202 may include a Central Processing Unit (CPU), a Graphics Processing Unit (GPU), or both. In another embodiment, the processor/controller 202 may be one or more general processors, digital signal processors, Application-Specific Integrated Circuits (ASICs), Field-Programmable Gate Arrays (FPGAs), servers, networks, digital circuits, analog circuits, combinations thereof, or other now known or later developed devices for analyzing and processing data. The processor/controller 202 may execute a software program, such as code generated manually (i.e., programmed) to perform the desired operation.

The processor/controller 202 may be disposed in communication with one or more Input/Output (I/O) devices via the I/O interface 204. The I/O interface 204 may employ communication techniques such as, but not limited to, Code-Division Multiple Access (CDMA), High-Speed Packet Access (HSPA+), Global System for Mobile communications (GSM), Long-Term Evolution (LTE), Worldwide Interoperability for Microwave Access (WiMax), or the like, etc.

Using the I/O interface 204, the system 200 may communicate with one or more I/O devices, specifically, the electronic device configured to generate and provide virtual environment to the user. For example, the input device may be an antenna, microphone, touch screen, touchpad, storage device, transceiver, video device/source, etc. The output devices may be a printer, fax machine, video display (e.g., Cathode Ray Tube (CRT), Liquid Crystal Display (LCD), Light-Emitting Diode (LED), plasma, Plasma Display Panel (PDP), Organic Light-Emitting Diode display (OLED) or the like), audio speaker, etc. In an embodiment, the system 200 may communicate with the electronic device associated with the user using the I/O interface 204.

The processor/controller 202 may be disposed in communication with a communication network via a network interface. In an embodiment, the network interface may be the I/O interface 204. The network interface may connect to the communication network to enable connection of the system 200 with the outside environment and/or device/system. The network interface may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc. The communication network may include, without limitation, a direct interconnection, Local Area Network (LAN), Wide Area Network (WAN), wireless network (e.g., using Wireless Application Protocol), the Internet, etc.

In an exemplary embodiment, the processor/controller 202 may be configured to perform context-based dynamic transformation of the surface reflection of the virtual entity in the virtual environment. The processor/controller 202 may be configured to obtain media data corresponding to the virtual entity and content data including extended reality frame of view data and metadata corresponding to the virtual environment including the virtual entity. In one non-limiting example, the media data may include media content stored at the media storage location in the personal computing device of the user, media content shared by the user associated with the virtual entity over a social network, media content that the user has interacted over the social network, and so forth. Examples of media content may include, but not limited to, images, videos, texts, graphics, and the like. Further, the extended reality frame of view data may include various components of the virtual environment such as, a background of the virtual environment, a foreground of the virtual environment, virtual entities in the virtual environment, and so forth. Specifically, the extended reality frame of view data may include virtual reality (VR) frame of view data, augmented reality (AR) frame of view data, or mixed reality (MR) frame of view data. The metadata may include, but is not limited to, a location of the virtual entity, an action of the virtual entity, a field of the view of the virtual entity, and a field of view of one or more neighboring virtual entities.

The processor/controller 202 may further be configured to generate a plurality of image context vectors and a plurality of extended reality context vectors based on the media data and each of the extended reality frame of view data and the metadata. In an embodiment, the processor/controller 202 may be configured to generate contextual information corresponding to each of the media data and the content data by performing techniques such as, but not limited to, image captioning and word embedding process on the received media data and the content data. Further, the processor/controller 202 may be configured to generate the plurality of image context vectors based on the generated contextual information corresponding to the media data. Furthermore, the processor/controller 202 may be configured to generate the plurality of extended reality context vectors based on the generated contextual information corresponding to the content data.

The processor/controller 202 may further be configured to perform a similarity mapping between the plurality of image context vectors and the plurality of extended reality context vectors. Specifically, the processor/controller 202 may be configured to identify a degree of similarity between the plurality of image context vectors and the plurality of extended reality context vectors. Moreover, the processor/controller 202 may be configured to filter one or more image context vectors among the plurality of image context vectors that are similar to one or more context vectors among the plurality of extended reality context vectors.

In an embodiment, the processor/controller 202 may be configured to determine a mapping index value based on the similarity mapping of the plurality of image context vectors and the plurality of extended reality context vectors. Further, the processor/controller 202 may be configured to determine whether the mapping index value corresponding to the similarity mapping is greater than a predefined threshold value associated with the mapping index. In one embodiment, the predefined threshold value may be defined based on information such as, but not limited to, previous usage data, theoretical data, user-related data, and so forth. In some other embodiments, the predefined threshold value may be defined by one or more users of the virtual environment.

Upon determining that the mapping index value is greater than the predefined threshold, the processor/controller 202 may be configured to determine at least one relevant contextual image vector with respect to the plurality of extended reality context vectors based on a content relevance ranking index. Specifically, the processor/controller 202 may be configured to determine a semantic correlation value for each of the media data and the content data based on at least one of image semantic information or textual information associated with the media data and the content data. Further, the processor/controller 202 may be configured to determine a semantic preference value for each of the media data and the content data based on a media exchange index, a media viewing index, and feedback-related information corresponding to the media data. Moreover, the processor/controller 202 may be configured to calculate the content relevance ranking index based on the semantic relevance value and the semantic preference value.

The processor/controller 202 may also be configured to generate a conditional tensor of the virtual entity by concatenating the at least one relevant contextual image vector with a plurality of reflection attributes associated with the virtual entity and at least one spatial attributes tensor corresponding to the virtual entity. Specifically, the processor/controller 202 may be configured to receive at least one image frame corresponding to the surface reflection of the virtual entity in the virtual environment. The processor/controller 202 may be configured to extract the surface reflection associated with the virtual entity and a background image from the at least one image frame. Further, the processor/controller 202 may be configured to segment the extracted surface reflection. Furthermore, the processor/controller 202 may be configured to identify one or more reflection attributes based on a result of the segmentation of the extracted surface reflection. The one or more reflection attributes may include attributes such as, but not limited to, an orientation, a dimension, and a body part posture.

In one embodiment, the processor/controller 202 may be configured to receive an image frame corresponding to the surface reflection of the virtual entity in the virtual environment. The processor/controller 202 may be configured to extract the surface reflection associated with the virtual entity and a background image from the at least one image frame. Further, the processor/controller 202 may be configured to segment the extracted surface reflection. Moreover, the processor/controller 202 may be configured to identify the plurality reflection attributes based on a result of the segmentation of the extracted surface reflection. Furthermore, the processor/controller 202 may be configured to generate the at least one spatial attributes tensor corresponding to the virtual entity based on the identified plurality of reflection attributes and the background image.

In an alternative embodiment, upon determining that the mapping index value is less than the predefined threshold value, the processor/controller 202 may be configured to identify user interest information corresponding to the user based on user-related metadata. Further, the processor/controller 202 may be configured to generate the plurality of image context vectors based on the user interest information. Furthermore, the processor/controller 202 may be configured to generate the conditional tensor of the virtual entity by concatenating the generated plurality of image context vectors and the at least one spatial attributes tensor corresponding to the virtual entity.

The processor/controller 202 may further be configured to transform the surface reflection of the virtual entity based on the generated conditional tensor using a Generative Adversarial Networks (GAN) model. The GAN model may be defined as a type of artificial neural network architecture used in Machine Learning (ML) and Deep Learning for generating data, such as, but not limited to, images, audio, or other structured data. Specifically, the processor/controller 202 may be configured to determine an action corresponding to the virtual entity based on at least one of the plurality of reflection attributes. Further, the processor/controller 202 may be configured to transform one or more action attributes corresponding to the surface reflection based on the determined action of the virtual entity. In a non-limiting example, the one or more action attributes indicate an essence of a movement or behavior associated with one or more living creatures representing the surface reflection. Further, the predefined action mapping data may include, but is not limited to, a plurality of actions corresponding to the virtual entity and a correlation of each of the plurality of actions with corresponding movements and behaviors associated the one or more living creatures. Moreover, the GAN model used for transforming the surface reflection of the virtual entity may include a modified GAN with a residual network and a cascading chain of conditional GANs.

In some embodiments, the processor/controller 202 may be configured to implement privacy control on display of the dynamically transformed surface reflection corresponding to the user. For instance, the processor/controller 202 may display the dynamically transformed surface reflection corresponding to the user to specific persons based on information such as, but not limited to, user profile, user preference, user connection, and user relation.

The processor/controller 202 may execute a set of instructions to perform the operations explained above. The processor/controller 202 may implement various techniques such as, but not limited to, Natural Language Processing (NLP), data extraction, Artificial Intelligence (AI), and so forth to achieve the desired objective.

In some embodiments, the memory 210 may be communicatively coupled to the at least one processor/controller 202. The memory 210 may be configured to store data, and instructions executable by the at least one processor/controller 202. In one embodiment, the memory 210 may communicate via a bus within the system 200. The memory 210 may include, but not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one example, the memory 210 may include a cache or random-access memory for the processor/controller 202. In alternative examples, the memory 210 is separate from the processor/controller 202, such as a cache memory of a processor, the system memory, or other memory. The memory 210 may be an external storage device or database for storing data. The memory 210 may be operable to store instructions executable by the processor/controller 202. The functions, acts or tasks illustrated in the figures or described may be performed by the programmed processor/controller 202 for executing the instructions stored in the memory 210. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing, and the like.

In some embodiments, the modules 206 may be included within the memory 210. The memory 210 may further include a database 212 to store data. The one or more modules 206 may include a set of instructions that may be executed to cause the system 200 to perform any one or more of the methods/processes disclosed herein. The one or more modules 206 may be configured to perform the operations of the present disclosure using the data stored in the database 212, for context-based dynamic transformation of the surface reflection of the virtual entity in the virtual environment. In an embodiment, each of the one or more modules 206 may be a hardware unit which may be outside the memory 210. Further, the memory 210 may include an operating system 214 for performing one or more tasks of the system 200, as performed by a generic operating system in the communications domain. The transceiver 208 may be configured to receive and/or transmit signals to and from the electronic device associated with the user. In one embodiment, the database 212 may be configured to store the information as required by the one or more modules 206 and the processor/controller 202 to perform one or more functions for generating the personalized shadow.

In an embodiment, the I/O interface 204 may enable input and output to and from the system 200 using suitable devices such as, but not limited to, display, keyboard, mouse, touch screen, microphone, speaker, and so forth.

Further, the present invention contemplates a computer-readable medium that includes instructions or receives and executes instructions responsive to a propagated signal. Further, the instructions may be transmitted or received over the network via a communication port or interface or using a bus (not shown). The communication port or interface may be a part of the processor/controller 202 or may be a separate component. The communication port may be created in software or may be a physical connection in hardware. The communication port may be configured to connect with a network, external media, the display, or any other components in system, or combinations thereof. The connection with the network may be a physical connection, such as a wired Ethernet connection or may be established wirelessly. Likewise, the additional connections with other components of the system 200 may be physical or may be established wirelessly. The network may alternatively be directly connected to the bus. For the sake of brevity, the architecture and standard operations of the operating system 214, the memory 210, the database 212, the processor/controller 202, the transceiver 208, and the I/O interface 204 are not discussed in detail.

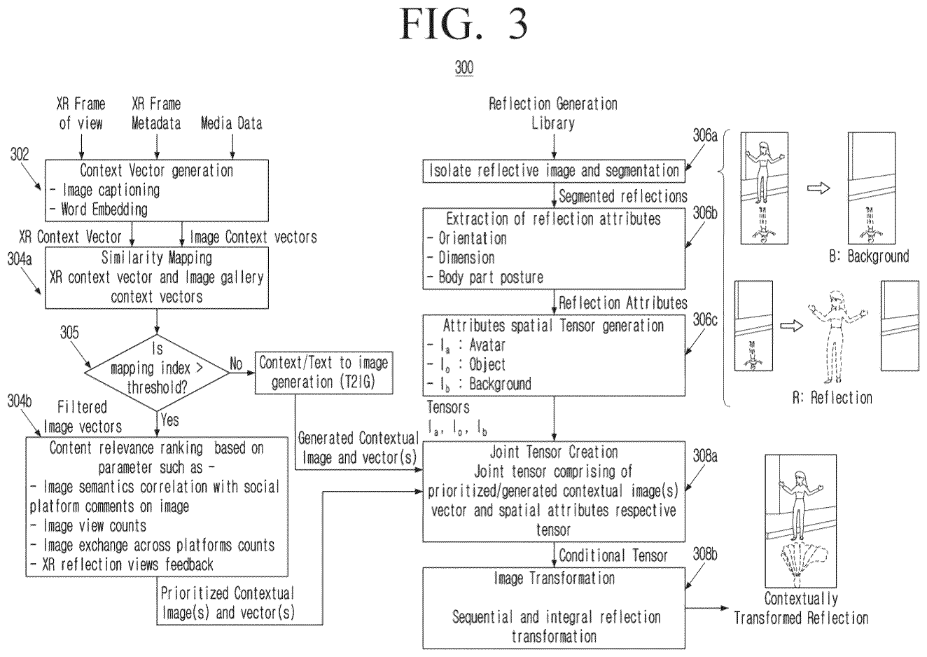

Further, a detailed explanation of various functionalities of the system 200 and/or the processor/controller 202 may be explained in view of FIGS. 3-10.

FIG. 3 illustrates a process flow of a method 300 for context-based dynamic transformation of a surface reflection of a virtual entity in a virtual environment, according to an embodiment of the present disclosure. In one embodiment, the method 300 may be implemented by the system 200.

At block 302, the method 300 includes obtaining the media data corresponding to the virtual entity and the content data including extended reality frame of view data (XR Frame of View) and metadata (XR Frame Metadata) corresponding to the virtual environment including the virtual entity. Further, the method 300 including generating the plurality of image context vectors and the plurality of extended reality context vectors (XR context vectors) based on the media data and the content data using techniques such as image captioning and word embedding processes.

During the image captioning processes, the method 300 includes capturing the XR frame of view and generating textual semantics to derive contextual information. Specifically, the method 300 includes generating captions for the obtained media data/content. In one embodiment, the method 300 includes utilizing techniques/networks such as, but not limited to, Convolution Neural Network (CNN), Long Short-Term Memory (LSTM) models, Recurrent neural network (RNN), and the like for generating the captions/textual semantic of the media data.

In an embodiment, the method 300 includes utilizing a Wavelet transform based Convolutional Neural Network (WCNN) with two level discrete wavelet decomposition for extracting visual feature maps highlighting the spatial, spectral, and semantic details from the media data to generate the captions/textual semantic. Further, a Visual Attention Prediction Network (VAPN) may be used to compute both channel and spatial attention for obtaining visually attentive features/visual feature maps. The method 300 may also include utilizing local features corresponding to the media data considering the contextual spatial relationship between different objects to generate the captions/textual semantic. Furthermore, the method 300 includes achieving a probability of the appropriate word prediction for the caption/textual semantic by combining the aforementioned architecture with an LSTM decoder network.

For performing the image captioning process, the method 300 further includes utilizing an encoder-decoder framework with a Visual Attention Private Network (VAPN) that converts an input image I (the media data) to a sequence of encoded words, for example:
W=[w1, w2, . . . , wL], with wi∈RN, describing the input image I, where L is the length of the generated caption/textual semantic and N is a vocabulary size.

The encoder-decoder frame may include the WCNN model that incorporates two levels of discrete wavelet decomposition combined with CNN layers to obtain the visual features of the input image I.

In one embodiment, the features maps obtained from the CNN layers may be bilinear down sampled and concatenated with other feature maps to produce a combined feature map, Fin of size, 32×32×960. The combined feature map the VAPN for obtaining attention based on the feature maps that highlights the semantic details in the input image I by exploiting channel as well spatial attention. In order to extract the contextual spatial relationship between the objects in input image I, the feature map of level L4 of the WCNN, F4, may be given to a Contextual Spatial relation Extractor (CSE) network. The contextual spatial feature map, Fcse, generated by the CSE network is concatenated with the attention based feature map, FAtt, to produce Fo and is provided to the language generation stage consisting of LSTM decoder network to generate the required textual semantics/captions.

In some embodiments, the method 300 may include utilizing convolutional networks with multi-receptive field filters that extract more semantic details from the input image I as such filters are capable of delivering a wider field of view. Such semantic details may be used to generate the required textual semantics/captions.

Further, the combined feature map, Fin, may be subjected to convolution and the resultant enhanced feature map of size 32×32×256, is given to a sequential combination of a Channel Attention (CA) network and a Spatial Attention (SA) network. For more accurate descriptions, the weights of channel attention (WC) and weight of spatial attention (WS) may be computed by considering ht−1∈RD, the hidden state of LSTM memory at (t−1) time step.

In the word embedding process, the method 300 may include representing individual words of a domain or language as real-valued vectors in a lower dimensional space. Specifically, the method 300 may include processing textual data along with the generated captions are processed to generate word vectors using GloVe (Global Vectors for words representation) pre-trained models. Specifically, the method 300 may include utilizing the GloVe models to use global matrix factorization methods like Latent Semantic Analysis (LSA) for generating low-dimensional word representations. Further, utilizing the GloVe models enables use of local context window methods such as the skip-gram model of Mikolov et al. The GloVe model may be defined as a log-bilinear model with a weighted least-squares objective. The main intuition underlying the GloVe model is a simple observation that ratios of word-word co-occurrence probabilities have the potential for encoding some form of meaning. For example, consider the co-occurrence probabilities for target words. For example, different names of companies may be linked with corresponding Chief Executive Officer (CEO). Further, names of cities may be linked with corresponding postal codes. In particular, the word embedding enables derivation of a specific meaning from the textual data.

In one embodiment, the generated word embedding vector space may provide comprehensive information on an individual's perspective on different contexts.

In an exemplary embodiment, the method 300 may include utilizing the VAPN for the image captioning and the GloVe model for the word embedding to generate the XR context vector(s) and image context vector(s), which are numerical representations of user's interaction within XR environment and semantically processed media content respectively.

At block 304a, the method 300 may include performing similarity mapping of the generated XR context vector(s) and image context vector(s) to generate a mapping index value and filter one or more image context vector(s).

Specifically, the method 300 includes performing the similarity mapping between the generated image vectors and the XR context vectors to classify image context vectors in different context spaces based on a nearest neighbor techniques. Further, the similarity mapping performed between the image vectors and the XR context vectors may be explained by following example.

Let's consider, there are two databases embedding x1 and x2, which are required to be quantized to one of two centers: c1 or c2. In particular, the goal is to quantize each xi to x′i such that an inner product <q, x′i> is as similar to an original inner product <q, xi> as possible. This enables maximization of inner product search.

At block 305, the method 300 includes determining whether the mapping index value corresponding to the similarity mapping is greater than a predefined threshold value associated with the mapping index value. For instance, the predefined threshold value may be defined as 60%.

Upon determining that the mapping index value is greater than the predefined threshold value, at block 304b includes determining at least one relevant contextual image vector with respect to the plurality of extended reality context vectors based on a content relevance ranking index. Specifically, the method 300 includes determining the content relevance ranking index based on parameters such as, but not limited to, image semantics correlation with social platform engagement with the media content (an image), view counts corresponding to the media content (the image), number of exchange of the media content across platforms, and feedback on the extended relation reflection views.

In one embodiment, the content relevance ranking index is determined to prioritize at least one of context image(s) and associated image context vector(s). In particular, the method 300 includes determining a semantic correlation value for each of the media data and the content data based on at least one of image semantic information or textual information associated with the media data and the content data. In one embodiment, the semantic correlation value may be determined using Pearson correlation coefficient (also called Pearson's r). The determined correlation value may be expressed with a value between −1 to 1, where −1 shows negative correlation while 1 indicates positive correlation. Further, the equation defining the use of Pearson correlation coefficient for determining the correlation value may be defined as Equation 1:

$$r = \frac{{\sum }_{i = 1}^{n} ( {x}_{i} - {x}^{″} ) ( {y}_{i} - {y}^{″} )}{\sqrt{{\sum }_{i = 1}^{n} {( {x}_{i} - {x}^{″} )}^{2}} \sqrt{{\sum }_{i = 1}^{n} {( {y}_{i} - {y}^{″} )}^{2}}} \qquad Eq . 1$$

Here, n is the sample size, xi and yi are the sample points, and x″ and y″ are the means of the samples. Pearson's r is essentially the covariance divided by the product of the standard deviations.

Embodiments are exemplary, any other suitable vector calculation method may be used to determine the correlation value. For instance, for the image semantic vector (T1) and text(s) vector (T2) in a spatial plane, the correlation between the two vectors T1 and T2 may be determined using vector mathematics where a planar angle between the two vectors provides the correlation. A value of correlation may be computed by taking a dot product of two vectors, which in geometric terms is a projection on one vector over another vector. Further, highly and positively correlated vectors may point toward a similar direction while negatively correlated vectors may point toward the opposite directions.

Further, to determine engagement with the media content (an image), the view counts corresponding to the media content (the image), the number of exchanges of the media content across platforms, and the feedback on the extended relation reflection views, the method 300 may include monitoring various services/applications running on an electronic device of the user. In an embodiment, the method 300 may include utilizing an on-device service module to track the user's image interactions across the associated social media platforms. The on-device service module may generate a log of the number of exchanges (E) and views (V) for each media content/data (image) across the associated social media platforms. The metrics may be represented as Ep and Vp, where ‘p’ stands for a specific platform. The method 300 may also include aggregating the generated data to create a comprehensive dataset of social media engagement with the most recent interactions. The on-device service module may also construct a tree of images (the media data) based on such interactions. Each image is represented as a node (N) in the tree, with attributes associated with total exchanges and views image has received across all platforms. Further, the feedback on the extended relation reflection views may be defined as a time of gauze on specific reflections by different users in the virtual environment. Specifically, the feedback on the extended relation reflection views may be based on duration and frequency of gauzing value on relevant content ranking for parameter F is determined, as discussed above.

Upon determining that the mapping index value is less than the predefined threshold value, the method 300 may proceed to block 304c where contextual image(s) and associated vectors may be generated based on the mapping index value and the XR frame context vectors. Specifically, in absence of relevant image map in the obtained media data in reference to the XR context vectors, the method 300 may include utilizing the GAN model for image generation. For instance, in the case of a brand promotion or a gaming scenario the contextual image(s) may be generated using the GAN model. In an alternative embodiment, the contextual image(s) may be directly inputted based on the mapping index value and the XR frame context vectors.

At block 306a, the method 300 includes isolating a reflecting image (i.e., the surface reflection) and performing segmentation of the media data. Further, the surface reflection may be isolation based on the received media data, the XR Frame of view, and the metadata.

Specifically, the method 300 may include separating a single image into two layers including a Background layer (B) and Reflection layer (R). The proposed method enables minimizing the correlation between the Background layer (B) and the Reflection layer (R). The method 300 includes performing segmentation on the image to segregate the Background layer (B) and the Reflection layer (R).

At block 306b, the method 300 includes extracting the plurality of reflection attributes. The plurality of reflection attributes may include, but are not limited to, an orientation, a dimension, and a body part posture. Specifically, the method 300 may include extraction of the plurality of reflection attributes corresponding to the surface reflection of the virtual entity based on the segregated Background layer (B) (may also be referred as “the background”) and the Reflection layer (R). The method 300 may include performing image processing to determine attributes of rendering reflection in reference to the virtual entity, object(s) such as rendering the orientation, the dimensions (length and width including concave and convex properties), and the body part posture. The method 300 may include processing image properties in grey scale to reduce pixel variation to a lower scale or binary. An object in a binary image is a set of connected pixels with the same value. The method 300 may include counting, labeling, and isolating objects/entities in the virtual environment, and measuring object properties such as area, body posture, and relative parts positioning using Deep Convolution Neural Network (DCNN).

In an embodiment, the orientation may be determined by identifying an area corresponding to the surface reflection of the virtual entity. Further, the method 300 may include segmenting the identified area into an imaginary major and minor axis within the identified area. Further, the method 300 may include calculating axis angles in reference to a reflection surface plane. In one embodiment, the orientation may be determined with a reference plane in vector/matrix form.

The dimensions corresponding to the surface reflection may include length and widths of the surface reflection rendered in the virtual environment. In one embodiment, one of the dimension of the surface reflection may be the major axis length of the identified area corresponding to the surface reflection. Further, the major axis length may be defined in pixels. The second dimension may be the minor axis length of the identified area corresponding to the surface reflection. Further, the minor axis length may be defined in pixels. In some embodiments, the surface reflection may correspond to a curved object/virtual entity along with the planar surface. In such case, the surface reflection may be of concave or concave having different shapes and sizes. Therefore, the dimension/transformed image reflection parameters may be determined using back propagation technique. Further, in case of the convex and the concave reflections, a scale up and a scale down matrices may be utilized, respectively.

The body part gesture may be generated using the DCNN network. Further, to determine the body part gesture a feature engineering model using the convolution layer may be employed using exponential in mathematical operator between image pixel value and kernel Σmul(x, e^{y})∀x−kernel value, y−image pixel value. The feature engineering model may take, as input, a color image of the virtual entity having size w×h and produces, as output, 2D locations of anatomical key points. Initially, a feedforward network may predict a set of 2D confidence maps S of body part locations and a set of 2D vector fields L of part vectors, which encode the degree of association between parts. The set S=(S1, S2, . . . , SJ) has J confidence maps, one per part, where Sj∈Mw×h, j∈{1 . . . J}. The set P=(P1, P2, . . . , PC) has C vector fields, one per Part 1, where Pc∈Mw×h×2, c∈{1 . . . . C}, each image location in Pc encodes a 2D vector. Finally, the confidence maps J and the affinity fields may be passed to an interface to output the 2D key points in the image.

The proposed method for extraction of reflection attributes may function on a lower scale of pixel values i.e., gray scale to determine the boundary and edges meaningful for pose detection and relative body parts positioning. Further, to perform such a process of extraction, the following changes are made to computation in convolution feature learning procedure:

$$\sum mul ( ex , ey ) ∀ x - kernel value , y - image pixel value .$$

As the functions used in extraction of the reflection attributes are exponential functions that are characterized by a principal that a growth rate of the function (i.e., a derivative) is directly proportional to a value of the function so the graph of y=abx is upward sloping and increases more rapidly as x increases. Based on this principal of the exponential functions the above changes were made to the convolution feature learning procedure to emphasize more on major features such as an outline of the shape (edges are more prominent in images) and less/no emphasis on small features such face attributes etc. In particular, during the surface reflection less emphasis is made on the minor features of the image.

At block 306c, the method 300 includes generating one or more spatial attributes tensors. Specifically, the method 300 may include receiving the reflection attributes determined as previous operation as input and generating one or more spatial attributes tensors (also referred to as attributes spatial tensors) as output. The method 300 may include determining a relative positioning of the different virtual entities in an entire image of the surface reflection. Initially, the different virtual entities can be achieved by segregating the virtual entities based on a type of the virtual entities such as avatar, object(s), and background. Further, a separate image layer may be created for each virtual entity, and a relative position on the planner surface and the depth of the virtual entity is determined.

The method 300 may include applying layered representations using layered object models for the image segmentation process that utilizes joint probability model to determine the layers of the input image w.r.t each virtual entity. Further, a relative depth orderings of detected virtual entity is determined. The method 300 includes generating multiple layers of object and modifying the layers using entity classification to classify the layers based on a type of the virtual entity associated with the layer. The method 300 may include generating a three layers of output, i.e., a background layer, an avatar layer, and an object layer. Firstly, the background from the input image is segmented and extracted as the background layer. As a next operation, all the person(s) and/or animals are segmented as avatars and extracted as the avatar layer. Lastly, all the remaining object(s) in the input image may be segmented as the object and extracted as the object layer. In an embodiment, related pixel values may be used to extract the three layers from the input image. Thereafter, reflection image(s) attributes may be encoded to generate comprehensive tensor featuring, for example, a position, a length, a width, a pose, and a surface. Moreover, based on generated tensor featuring, the spatial attributes tensor(s) Ia (for avatars), Io (for objects), and Ib (for background) may be generated for each layer using an image encoding model. Specifically, an image to text encoder decoder model is constructed to train the image encoder for tensor generation that comprehensively captures attributes details including interlayer relative positioning. Further, a training of image to text model is done until the encoder explicitly explains image in terms of defined attributes.

At block 308a, the method 300 may include receiving the generated contextual image and/or the associated vector(s), or the prioritize contextual image and/or the contextual vector(s), and the one or more spatial attributes tensors as input and generate a conditional tensor of the virtual entity. In one embodiment, the method 300 may include concatenating the prioritized contextual image (avatar and/or object(s)) contextual vector(s) to generate a single conditional tensor for dynamic generation of transformed surface reflection(s). In particular, the dimensions corresponding to the contextual image vectors may be updated with reference to the dimensionality of reflections' attributes tensor to enable stacking of two tensors achieve the required single tensor. In some embodiments, the stacking of the tensors may be used over concatenation as to combine separate coordinates into vectors space considering that contextual image vectors and attributes tensor will be in different planes. The generated single tensor may serve as the conditional tensor to the GAN model responsible for dynamic generation of transformed surface reflection(s).

At block 308b, the method 300 includes generating contextual transformed surface reflection of the virtual entity in the virtual environment. The method 300 includes receiving conditional tensor as input and performing sequential and integral transformation of the surface reflection corresponding to the virtual entity. In an embodiment, the method 300 may include using cascading GAN (cGAN) model also referred as Transform Reflection GAN (TRGAN) for performing transformation of the surface reflections. In TRGAN, a chain of conditional GANs may be used to optimize redundancy elimination in the model. Additionally, a residual network may be used in the cascading network to provide an integral solution. Further, the tensors corresponding to the avatar(s), the object(s), and the background may be separated considering that the tensors remain the same at a single time instance. If there is no change either in the avatar(s), the object(s), or the background, the whole image frame may not be processed and only a selection of the input image may be processed for transformation of the surface reflection.

Specifically, the method 300 may include utilizing a different GAN model for each layer, i.e., the avatar layer, the object layer, and the background layer. For instance, the GAN model used for processing tensors corresponding to the avatar(s) may include a Generator A (GenA) and a Discriminator A (DisA), for processing tensors corresponding to the object(s) may include a GenO and a DisO, and for processing tensors to corresponding to the background may include a GenB and a DisB. Further, the method 300 may include individual processing for tensors corresponding to each layer to avoid redundant processing in case other tensors do not change. Specifically, in individual processing of the tensor (Ia) corresponding to the avatar(s), the GenA may receive Noise (z) as input along with conditional tensor Ia. The GenA may generate the transformed reflection image of the avatar(s) and provide the transformed reflection image to the DisA for performing validation of real/fake. The DisA may take real image input derived from the prioritized contextual image vector to validate the transformed reflection image. Similar processing may be done for the tensors (Io and Ib) that may correspond to the object(s) and the background. Additionally, in case of tensor Io, the GenA may generate the contextual image as a residual network input, thereby validating the integrated image of the avatar, and the object. Also, the DisB may receive the GenB generated image as a residual network input, thereby validating the integrated image of the avatar, the object, and the background. Further, in one embodiment, the output of the GenB may be replaced with the background reflection directly and validated by the DisB in reference to the integrated residual network output received from the GenO.

Thus, the method 300 may be able to dynamically transform the surface reflection based on the contextual information to enhance the user experience in the virtual environment.

For instance, let's consider a virtual environment representing a marathon track. The proposed method may take one or more user images as input from an image gallery application from a mobile device of the user. The one or more user images may be selected based on parameters as discussed above. Based on such one or more user images, the proposed method may transform the surface reflection of the avatar of the user to represent the user as running. Specifically, the proposed method includes accurately applied each of the avatar's pose/action to corresponding contextually transformed reflection.

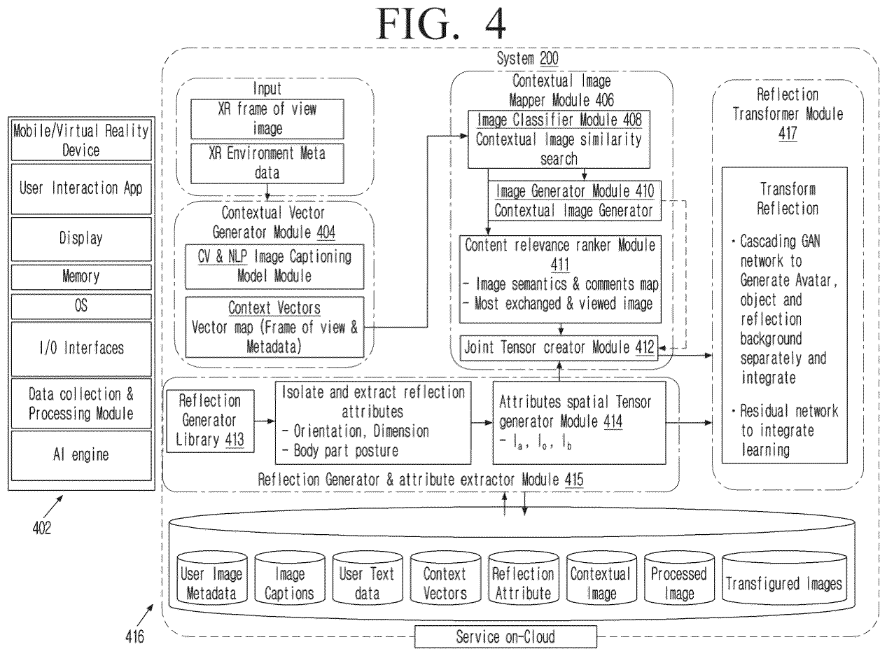

FIG. 4 illustrates an architectural block diagram of the system 200 for context-based dynamic transformation of the surface reflection of the virtual entity in the virtual environment, according to an embodiment of the present disclosure. The system 200 may include a contextual vector generator module 404, a contextual image mapper module 406, a reflection transformer module 417, and a database/memory 416.

The system 200 may be communicably coupled to a mobile device/a virtual reality device 402. The mobile device/virtual reality device 402 may be configured to enable the user to access and/or experience the virtual environment. The virtual reality device 402 may include electronic device such as, but not limited to, a head-mounted display device, a smartphone, a virtual reality headset, virtual reality glasses or any other suitable device configured to generate and/or render the virtual environment. The virtual reality device 402 may various components including a user interaction application, a display, a memory, a I/O interfaces, a data collection and processing module, an Artificial Intelligence (AI) engine. The user interaction application may be configured to enable a user to interact with the virtual reality device 402. The display may be configured to display the virtual environment and related information to the user. The memory may be configured to store a set of instruction and/or data required to render and display the virtual environment. The I/O interfaces may be configured to enable additional components/devices to connect with the virtual reality device 402. The data collection and processing module may be configured to monitor and collect user logs when the user access the virtual environment. Further, the AI engine may be configured to implement one or more functionality of the virtual reality device 402 required for rendering and providing the virtual environment to the user. Embodiments are exemplary in nature and the virtual reality device 402 may include any additional component or may omit any of the above-mentioned component as per requirement. Further, the components of the virtual reality device 402 may have conventional structure or may also perform one or more conventional functions, thus a detailed description of the components of the virtual reality device 402 is omitted for the sake for brevity.

The contextual vector generator module 404 may be configured to receive the extended reality frame of view data (XR frame of view image) and metadata (XR environment metadata) corresponding to the virtual environment including the virtual entity, as input. In some embodiments, the contextual vector generator module 404 may also be configured to receive media data associated with the user of the virtual environment, as input. The contextual vector generator module 404 may further be configured to process the received input for Contextual Vector (CV) and Natural Language Processing (NLP) to generate the corresponding contextual vectors. The contextual vector generator module 404 may also be configured to generate textual semantics and/or captions for the received input data. In one embodiment, the contextual vector generator module 404 may be configured to generate a vector map corresponding to received extended reality frame of view data and metadata. Further, the contextual vector generator module 404 may be configured to provide a generated output to the contextual image mapper module 406.

The contextual image mapper module 406 may be configured to vectorize media data (such as, personal images of the user) and classify the vectorized media data to map with the contextual vector(s) received from the contextual vector generator module 404. The contextual image mapper module 406 may also be configured to segregate the media data (for example, images included in media data), to prioritize the images in the media data to identify a suitable match for the surface reflection of the virtual entity in the virtual environment.

In an embodiment, the contextual image mapper module 406 may include an image classifier module 408 configured to identify contextual image from the media data based on a similar search. Specifically, the image classifier module 408 may be configured to filter, based on a similarity mapping between the plurality of image context vectors corresponding to the media data and the plurality of extended reality context vectors, one or more image context vectors among the plurality of image context vectors that are similar to one or more context vectors among the plurality of extended reality context vectors.

Further, for the cases of non-similar contextual vectors i.e., with low or no match of the one or more image context vector and the one or more extended reality context vector, the contextual image mapper module 406 may also include an image generator module 410 configured to generate a contextual image based on the one or more contextual vectors corresponding extended reality frame of view and metadata. Specifically, the image generator module 410 may be configured to the contextual image based on the context of the virtual environment.

In some embodiments, the output of the image classifier module 408 may be fed to a context relevance ranker module 411. The context relevance ranker module 411 may be configured to generate textual semantics and/or captions for the one or more identified images and/or one or more image vectors corresponding to the media data. The context relevance ranker module 411 may also be configured to identify at least one image from the media data based on user-interest information. The user interest information may be determined based on user's engagement with the media data.

The contextual image mapper module 406 may further include a joint tensor creator module 412 configured to generate a conditional tensor of the virtual entity by concatenating the at least one contextual image vector with a plurality of reflection attributes associated with the virtual entity and at least one spatial attributes tensor corresponding to the virtual entity. The plurality of reflection attributes may be generated by a reflection generator and attribute extractor module 415.

The reflection generator and attribute extractor module 415 may be configured to generate and segregate surface reflections corresponding to the virtual entities in the virtual environment. The reflection generator and attribute extractor module 415 may include a reflection generator library 413 including information/data such as, but not limited to, generic surface reflections, object images, templates for surface reflection generation, and so forth.

The reflection generator and attribute extractor module 415 may also be configured to isolate and extract reflection attributes from the surface reflection of the virtual entity. Such reflection attributes may include, but are not limited to, the orientation, the dimensions, and the body part posture.

The reflection generator and attribute extractor module 415 may further include an attributes spatial tensor generator module 414 configured to generate spatial tensor(s) (for example, Ia, Ib, Io) corresponding to extracted reflection attributes. The generated tensor corresponding to the reflection attributes may be fed to the joint tensor creator module 412 to generate the conditional tensor of the virtual entity.

The reflection transformer module 417 may be configured to transform the surface reflection corresponding to the virtual entity by applying GAN model (TRGAN) that is modified cGAN cascaded to generate surface reflections of avatar(s), object(s), and background separately with residual network to integrate surface reflection learning thereby reducing redundant processing in case any surface reflection is not changing. Specifically, the reflection transformer module 417 is configured to transform the surface reflection of the virtual entity based on the generated conditional tensor by the joint tensor creator module 412. The reflection transformer module 417 may also be configured to receive inputs from reflection generator and attribute extractor module 415 to transform the surface reflection of the virtual entity in the virtual environment.

The system 200 may also include the database/memory 416 communicably coupled to the modules 404, 408, 410, 411, 412, 413, 414, 415, and 417 of the system 200. The database/memory 416 may be configured to store user image metadata, image caption, user text data, context vectors, reflection attributes, contextual image, processed image, and the transfigured image. The modules 404, 408, 410, 411, 412, 414, 415, and 417 may be configured to utilize the information stored in the database/memory 416 as per the requirement. Further, the modules 404, 408, 410, 411, 412, 414, 415, and 417 may correspond to the one or more modules 206, as shown in FIG. 2.

In an embodiment, the system 200 may be implemented over a cloud network. In another embodiment, the system 200 may be partially implemented over the cloud and may partially implemented locally.

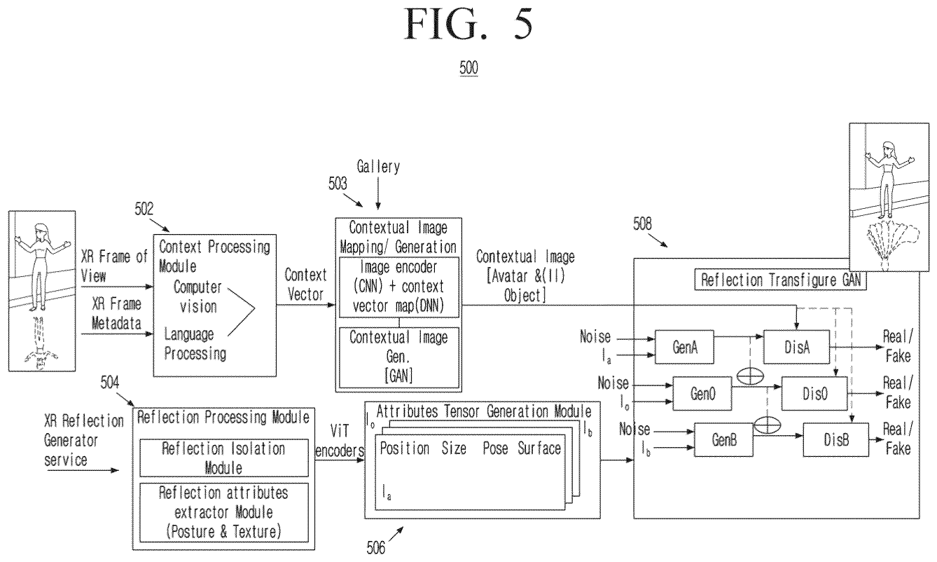

FIG. 5 illustrates a process flow 500 of dynamically transforming the surface reflection of the virtual entity in the virtual environment, according to an embodiment of the present disclosure.

At block 502, a context processing module 502 may receive the extended reality frame of view (XR frame of view) and the associated metadata (XR frame metadata) as input. The context processing module 502 is configured to apply techniques such as, but not limited to, computer vision, language processing, etc., on the received input to generate corresponding context vector(s).

At block 503, the media data and the generated context vector(s) may be processed using techniques such as, but not limited to, image encoding, context vector map generation, contextual image generation, and so forth. The techniques may be performed using suitable neural networks such as, but not limited to, CNN, DNN, GAN, and so forth. Specifically, at block 503, contextual image corresponding to the avatar and/or the object may be generated.

At block 504, a reflection processing module may receive reflection-related information from an extended reality reflection generator service (XR Reflection Generator service). The reflection processing module is configured to process the received input using a reflection isolation module that is configured to isolate avatar, objects, and background from the received input. Further, the reflection processing module may include a reflection attributes extractor module configured to extract reflection attributes corresponding to the surface reflection of the virtual entity.

At block 506, an attributes tensor generation module may be configured to generate tensors corresponding to the extracted reflection attributes. The tensor may include information such as, but not limited to, position, size, pose, and surface of the surface reflection.

At block 508, a reflection transfigure GAN may transform and/or generate the surface reflection of the virtual entity and also identify whether the transformed and/or generated surface reflection is real or fake. The reflection transfigure GAN may utilize distinct Generator and Discriminator for each of the exacted tensor and/or surface reflection layer, to avoid redundant processing in case there is no change in any of the tensor and/or the surface reflection layer.

Various modules as described in reference to the process flow 500 may be the part of the system 200 and/or may correspond to the one or more modules 206.

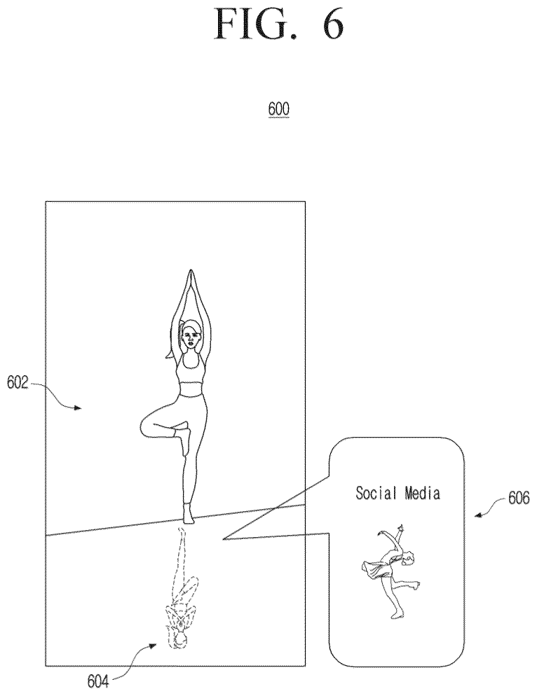

FIG. 6 illustrates a first example scenario depicting a virtual entity 602 with a dynamically transformed surface reflection 604 in a virtual environment 600, according to an embodiment of the present disclosure. The virtual entity 602 may correspond to an avatar of a user of the virtual environment 600 where a body past posture of the avatar may resemble dancing. Therefore, the surface reflection of the virtual entity 602 may be dynamically transformed based on an image on a social media platform 606 associated with the user. The image selected for dynamically transforming the surface reflection of the virtual entity 602 may correspond to the contextual image (as discussed above). The selected image may be dynamically transformed to align with a dancing style of the virtual entity 602. Thus, by providing a contextual image based on user action, the present disclosure may provide the user with better user experience while interacting with the virtual environment 600.

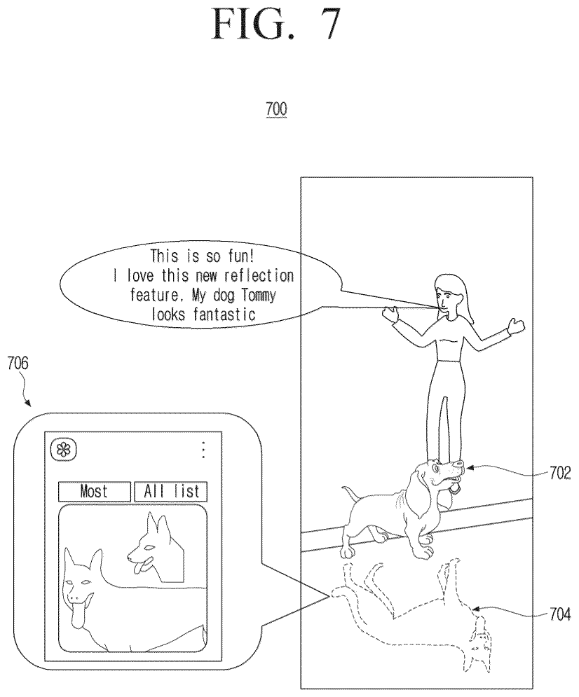

FIG. 7 illustrates a second example scenario depicting a virtual entity 702 with a dynamically transformed surface reflection 704 in a virtual environment 700, according to another embodiment of the present disclosure. Here, the virtual entity 702 is a pet of the user's avatar. Further, the dynamically transformed surface reflection 704 is real-life representation of their pets which may be identified through media 706 stored in user's electronic device. Thus, the present disclosure enables pet owners to have real-life representation of their pets in the form of surface reflection of their pets in the virtual environment 700 adding a unique and personalized user experience for the user of the virtual environment 700.

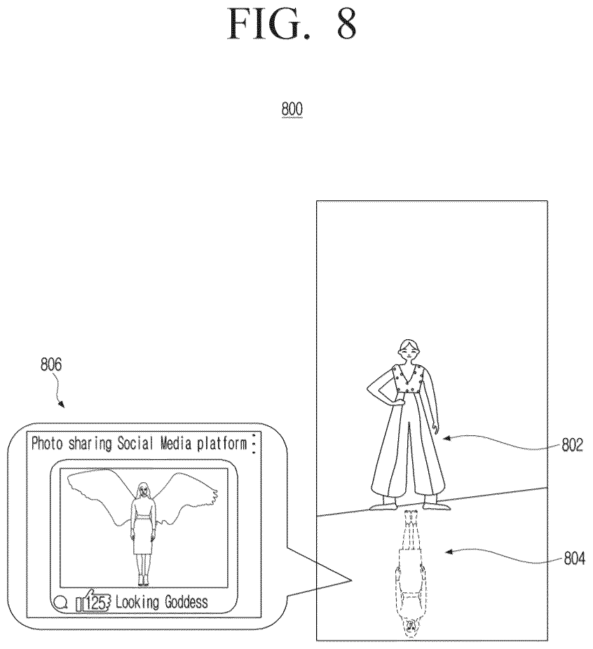

FIG. 8 illustrates a third example scenario depicting a virtual entity 802 with a dynamically transformed surface reflection 804 in a virtual environment 800, according to another embodiment of the present disclosure. In the illustrated embodiment, the virtual entity 802 may correspond to an avatar of the user in the virtual environment 800. Further, the virtual environment 800 may correspond to a virtual fashion show, where when the user walks, the dynamically transformed surface reflection 804 may represent real-life reflection of the user wearing a fashionable outfit. The real-life reflection may be generated using an image 806 that the user has posted on a social media platform. The image 806 may be selected based on a number of engagements by the user or other users connected to the user over the social media platform. Thus, the present disclosure may create a hybrid of virtual and real-like fashion expressions.

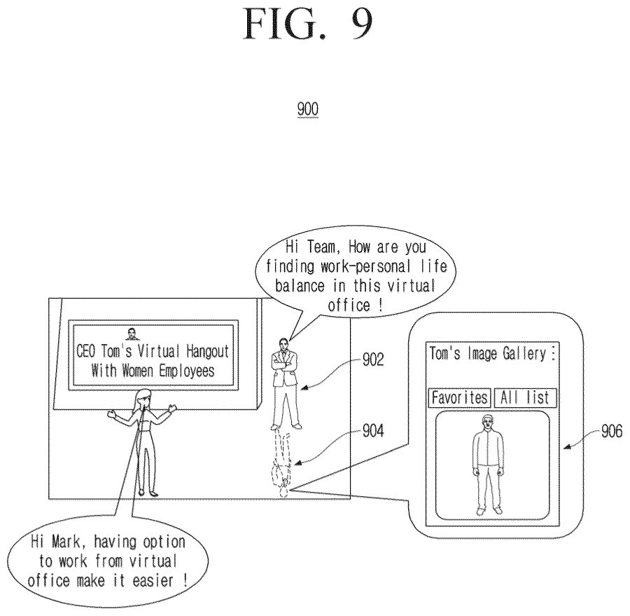

FIG. 9 illustrates a fourth example scenario depicting a virtual entity 902 with a dynamically transformed surface reflection 904 in a virtual environment 900, according to another embodiment of the present disclosure. The virtual environment 900 may correspond to an office environment corresponding to a company where the virtual entity 902 may represent a Chief Executive Officer (CEO) and other virtual entity may represent an employee. The virtual environment 900 illustrates an interaction of the employee with the CEO. The solution of the present disclosure generates the dynamically transformed surface reflection 904 that represents real-life image of the CEO/the virtual entity 902. The real-life image of the CEO may be taken from as media data 906 from an electronic device of the CEO. Further, by dynamically transforming surface reflection of the CEO, the present disclosure enhances overall virtual hangout experience.

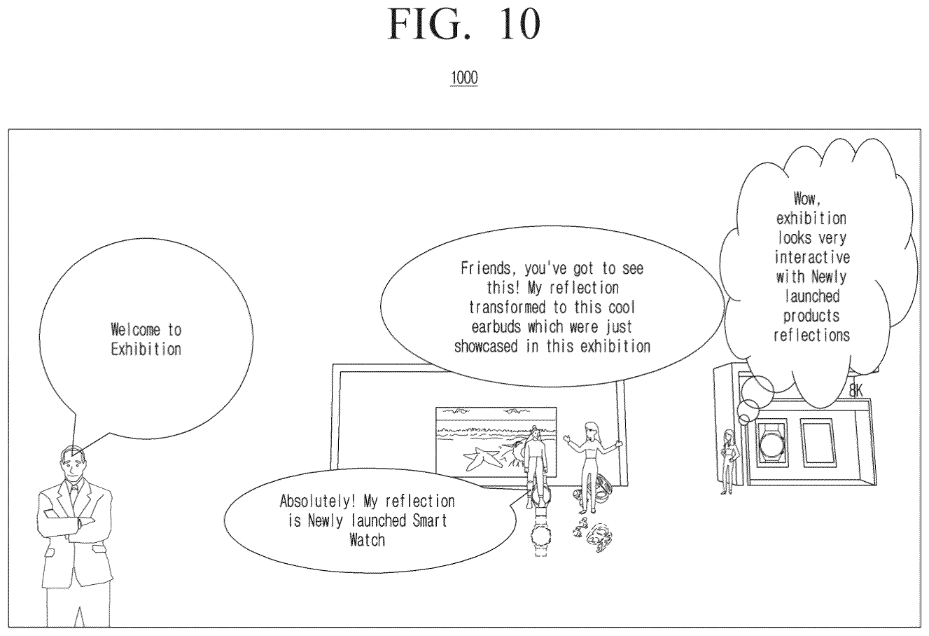

FIG. 10 illustrates a first use case example diagram depicting various virtual entities with dynamically transformed surface reflections in a virtual environment 1000, according to an embodiment of the present disclosure. The virtual environment 1000 may correspond to a virtual exhibition of electronic gadgets and the dynamically transformed surface reflections may correspond to images of such electronic gadgets. Thus, the solution of the present disclosure provides a new way of promoting products in the virtual environment.

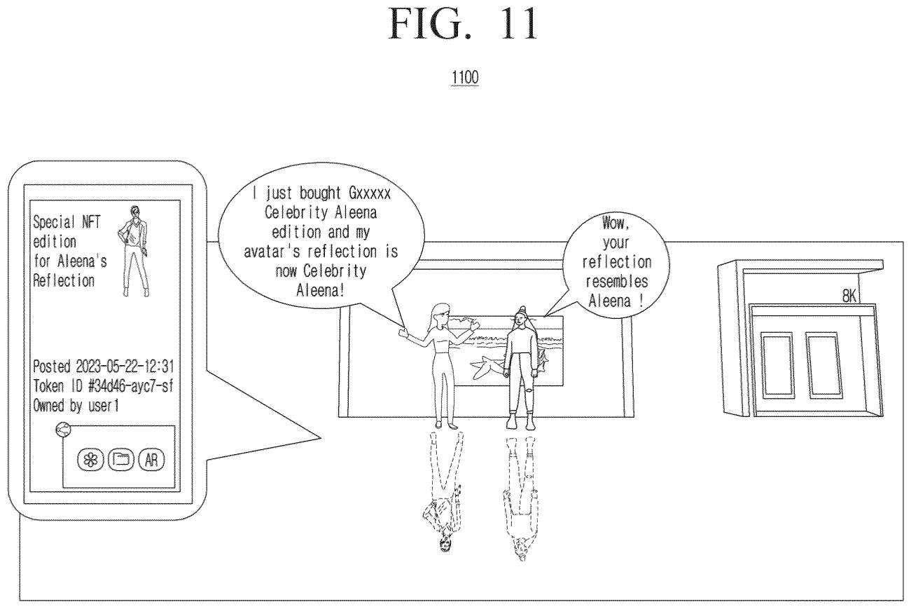

FIG. 11 illustrates a second use case example diagram depicting various virtual entities with dynamically transformed surface reflections in a virtual environment 1100, according to another embodiment of the present disclosure. The virtual environment 1100 may correspond to a virtual exhibition of electronic gadgets/services corresponding to a brand or a company. Further, the dynamically transformed surface reflection may correspond to a Non-Fungible Token (NFT) purchased by the user. In some embodiments, the dynamically transformed surface reflections may correspond to a modified NFT purchased by the user.

In some embodiments, in the absence of relevant image map in the media storage location of the electronic device of the user, the contextual image of dynamically transforming surface reflection may be generated based on user's interests. The user's profile on a social media platform may be monitored to identify the user's interest.

In some embodiments, when the virtual environment may correspond to a gaming environment for example, a virtual fight game. Then, the surface reflections of the virtual entities may be transformed into an arsenal of tools, weapons, or abilities of the corresponding characters. The arsenal of tools as avatar's reflection will help players remember and effectively use the arsenal like hand cannon gadget, powerful projectile weapons, stylized gun, etc. In some other embodiments, the surface reflections of the characters may be transformed to an animal mimicking the character's style, power, voice, and the like. Thus, the proposed solution enhances the overall gaming experience of the user in the virtual environment.

In some embodiments, the surface reflections corresponding to an object such as a car, may be changed to a real-like image of the object to all the user to virtually explore the object in a better and efficient manner.

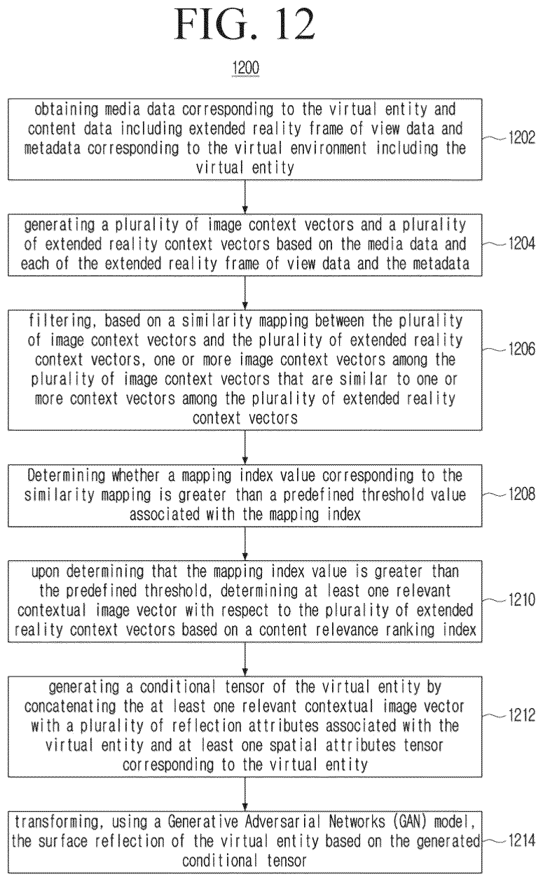

FIG. 12 illustrates an exemplary process flow of a method 1200 for context-based dynamic transformation of the surface reflection of the virtual entity in the virtual environment, according to an embodiment of the present disclosure.

At operation 1202, the method 1200 includes obtaining media data corresponding to the virtual entity and content data including extended reality frame of view data and metadata corresponding to the virtual environment including the virtual entity. The metadata corresponding to the virtual environment may include information such as, but not limited to, a location of the virtual entity, an action of the virtual entity, a field of the view of the virtual entity, and a field of view of one or more neighboring virtual entities.

At operation 1204, the method 1200 includes generating a plurality of image context vectors and a plurality of extended reality context vectors based on the media data and the content data. Specifically, the method 1200 may include generating contextual information corresponding to each of the media data and the content data by performing at least one of an image captioning process or a word embedding process on the media data and the content data. Further, the method 1200 includes generating the plurality of image context vectors based on the generated contextual information corresponding to the media data. Moreover, the method 1200 includes generating the plurality of extended reality context vectors based on the generated contextual information corresponding to the content data.

At operation 1206, the method 1200 includes filtering, based on a similarity mapping between the plurality of image context vectors and the plurality of extended reality context vectors, one or more image context vectors among the plurality of image context vectors that are similar to one or more context vectors among the plurality of extended reality context vectors.

At operation 1208, the method 1200 includes determining whether a mapping index value corresponding to the similarity mapping is greater than a predefined threshold value associated with the mapping index value.

At operation 1210, the method 1200 includes upon determining that the mapping index value is greater than the predefined threshold value, determining at least one relevant contextual image vector with respect to the plurality of extended reality context vectors based on a content relevance ranking index. The method 1200 includes determining a semantic correlation value for each of the media data and the content data based on at least one of image semantic information or textual information associated with the media data and the content data. Further, the method 1200 includes determining a semantic preference value for each of the media data and the content data based on a media exchange index, a media viewing index, and feedback-related information corresponding to the media data. Furthermore, the method 1200 includes calculating the content relevance ranking index based on the semantic relevance value and the semantic preference value. Alternatively, upon determining that the mapping index value is less than the predefined threshold value, the method 1200 may include identifying user interest information corresponding to the user based on user-related metadata. Further, the method 1200 may include generating the plurality of image context vectors based on the user interest information. Moreover, the method 1200 may include generating the conditional tensor of the virtual entity by concatenating the generated plurality of image context vectors and the at least one spatial attributes tensor corresponding to the virtual entity.

At operation 1212, the method 1200 includes generating a conditional tensor of the virtual entity by concatenating the at least one relevant contextual image vector with a plurality of reflection attributes associated with the virtual entity and at least one spatial attributes tensor corresponding to the virtual entity. The method 1200 may include receiving at least one image frame corresponding to the surface reflection of the virtual entity in the virtual environment. The method 1200 may also include extracting the surface reflection associated with the virtual entity and a background image from the at least one image frame. The method 1200 may further include segmenting the extracted surface reflection. Moreover, the method 1200 may include identifying the plurality reflection attributes based on a result of the segmentation of the extracted surface reflection. Furthermore, the method 1200 may include generating the at least one spatial attributes tensor corresponding to the virtual entity based on the identified plurality of reflection attributes and the background image.

At operation 1214, the method 1200 includes transforming, using a Generative Adversarial Networks (GAN) model, the surface reflection of the virtual entity based on the generated conditional tensor. The method 1200 may also include determining an action corresponding to the virtual entity based on at least one of the plurality of reflection attributes. Furthermore, the method 1200 may include transforming, using a predefined action mapping data, one or more action attributes corresponding to the surface reflection based on the determined action of the virtual entity, wherein the one or more action attributes indicates an essence of a movement or behavior associated with one or more living creatures representing the surface reflection.

The present invention provides for various technical advancements based on the key features discussed above. Further, the present invention may enable an effective and efficient transformation of surface reflection of virtual entities in the virtual environment. The present disclosure provides a personalized and interactive virtual world experience using personalized and contextual surface reflections. Moreover, the present disclosure enhances user experience and interaction in the virtual environment using interactive, personalized, and contextual surface reflections.

While specific language has been used to describe the present subject matter, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

1. A method for context-based dynamic transformation of a surface reflection of a virtual entity in a virtual environment, the method comprising:
obtaining media data corresponding to the virtual entity and content data including extended reality frame of view data and metadata corresponding to the virtual environment including the virtual entity;
generating a plurality of image context vectors and a plurality of extended reality context vectors based on the media data and the content data;
filtering, based on a similarity mapping between the plurality of image context vectors and the plurality of extended reality context vectors, one or more image context vectors among the plurality of image context vectors that are similar to one or more context vectors among the plurality of extended reality context vectors;
determining whether a mapping index value corresponding to the similarity mapping is greater than a predefined threshold value associated with the mapping index value;
determining, based on the mapping index value being determined to be greater than the predefined threshold value and a content relevance ranking index, at least one relevant contextual image vector with respect to the plurality of extended reality context vectors;
generating a conditional tensor of the virtual entity by concatenating the at least one relevant contextual image vector with a plurality of reflection attributes associated with the virtual entity and at least one spatial attributes tensor corresponding to the virtual entity; and
transforming, using a Generative Adversarial Networks (GAN) model, the surface reflection of the virtual entity whereby the surface reflection of the virtual entity is controlled to reflect context-based effect based on the generated conditional tensor.

2. The method as claimed in claim 1, wherein the metadata corresponding to the virtual environment comprise at least one of a location of the virtual entity, an action of the virtual entity, a field of view of the virtual entity, and a field of view of one or more neighboring virtual entities.

3. The method as claimed in claim 1, wherein generating the plurality of extended reality context vectors and the plurality of image context vectors comprises:
generating contextual information corresponding to each of the media data and the content data by performing at least one of an image captioning process or a word embedding process on the media data and the content data;
generating the plurality of image context vectors based on the generated contextual information corresponding to the media data; and
generating the plurality of extended reality context vectors based on the generated contextual information corresponding to the content data.

4. The method as claimed in claim 1, comprising:
determining a semantic correlation value for each of the media data and the content data based on at least one of image semantic information or textual information associated with the media data and the content data;
determining a semantic preference value for each of the media data and the content data based on a media exchange index, a media viewing index, and feedback-related information corresponding to the media data; and
calculating the content relevance ranking index based on the semantic correlation value and the semantic preference value.

5. The method as claimed in claim 1, comprising:
receiving at least one image frame corresponding to the surface reflection of the virtual entity in the virtual environment;
extracting the surface reflection associated with the virtual entity and a background image from the at least one image frame;
segmenting the extracted surface reflection;
identifying the plurality of reflection attributes based on a result of the segmenting of the extracted surface reflection; and
generating the at least one spatial attributes tensor corresponding to the virtual entity based on the identified plurality of reflection attributes and the background image.

6. The method as claimed in claim 1, wherein, upon determining that the mapping index value is less than the predefined threshold value, the method comprises:
identifying interest information corresponding to a user based on user-related metadata;
generating the plurality of image context vectors based on the interest information corresponding to the user; and
generating the conditional tensor of the virtual entity by concatenating the generated plurality of image context vectors and the at least one spatial attributes tensor corresponding to the virtual entity.

7. The method as claimed in claim 1, wherein the media data comprises one or more of images, texts, and videos available at one or more of social media platforms or media storage locations corresponding to a user.

8. The method as claimed in claim 1, wherein the extended reality frame of view data includes at least one of virtual reality (VR) frame of view data, augmented reality (AR) frame of view data, or mixed reality (MR) frame of view data.

9. The method as claimed in claim 1, wherein the plurality of reflection attributes comprises at least one of an orientation, dimensions, and a body posture corresponding to the virtual entity.

10. The method as claimed in claim 9, wherein transformation of the surface reflection of the virtual entity comprises:
determining an action corresponding to the virtual entity based on at least one of the plurality of reflection attributes; and
transforming, using a predefined action mapping data, one or more action attributes corresponding to the surface reflection based on the determined action of the virtual entity, wherein the one or more action attributes indicates an essence of a movement or behavior associated with one or more living creatures representing the surface reflection.

11. The method as claimed in claim 10, wherein the predefined action mapping data comprises a plurality of actions corresponding to the virtual entity and a correlation of each of the plurality of actions with corresponding movements and behaviors associated the one or more living creatures.

12. The method as claimed in claim 1, wherein the GAN model used for transforming the surface reflection of the virtual entity comprises a modified GAN with a residual network and a cascading chain of conditional GANs.

13. A system for context-based dynamic transformation of a surface reflection of a virtual entity in a virtual environment, the system comprising:
a memory; and
at least one processor communicably coupled with the memory, the at least one processor is configured to:
obtain media data corresponding to the virtual entity and content data including extended reality frame of view data and metadata corresponding to the virtual environment including the virtual entity;
generate a plurality of image context vectors and a plurality of extended reality context vectors based on the media data and the content data;
filter, based on a similarity mapping between the plurality of image context vectors and the plurality of extended reality context vectors, one or more image context vectors among the plurality of image context vectors that are similar to one or more context vectors among the plurality of extended reality context vectors;
determine whether a mapping index value corresponding to the similarity mapping is greater than a predefined threshold value associated with the mapping index value;
determining, based on the mapping index value being determined to be greater than the predefined threshold value and a content relevance ranking index, at least one relevant contextual image vector with respect to the plurality of extended reality context vectors;
generate a conditional tensor of the virtual entity by concatenating the at least one relevant contextual image vector with a plurality of reflection attributes associated with the virtual entity and at least one spatial attributes tensor corresponding to the virtual entity; and
transform, using a Generative Adversarial Networks (GAN) model, the surface reflection of the virtual entity whereby the surface reflection of the virtual entity is controlled to reflect context-based effect based on the generated conditional tensor.

14. The system as claimed in claim 13, wherein the metadata corresponding to the virtual environment comprise at least one of a location of the virtual entity, an action of the virtual entity, a field of view of the virtual entity, and a field of view of one or more neighboring virtual entities.

15. The system as claimed in claim 13, wherein to generate the plurality of extended reality context vectors and the plurality of image context vectors, the at least one processor is configured to:
generate contextual information corresponding to each of the media data and the content data by performing at least one of image captioning process or a word embedding process on the media data and the content data;
generate the plurality of image context vectors based on the generated contextual information corresponding to the media data; and
generate the plurality of extended reality context vectors based on the generated contextual information corresponding to the content data.
